(19) United States
(12) Patent Application Publication
(10) Pub. No.: US 2007/0220930 A1
(43) Pub. Date: Sep. 27, 2007

(54) D1-DMJ

(76) Inventor: Don McDonald JR., Grand Prairie, TX (US)

Correspondence Address: Mr. Don McDonald, Jr., 4311 Meadowside Court, Grand Prairie, TX, 75052, US

(21) Appl. No.: 10/897,798

(22) Filed: Nov. 15, 2004

Related U.S. Application Data
(60) Provisional application No. 60/489,534, filed on Jul. 24, 2003.

(51) Int. Cl. E05B 73/00

(52) U.S. Cl. 70/58

(57) ABSTRACT

The D1-DMJ bracket is fabricated from 0.08 thick 5052-H32 aluminum. It has a black powder coat (fine) finish. It's bend radius is 0.09. It can however be customized to meet the color and logo specifications of the customer. All edges are deburred. The D1-DMJ uses allen or similar bolts for adhering the device to a telephone.

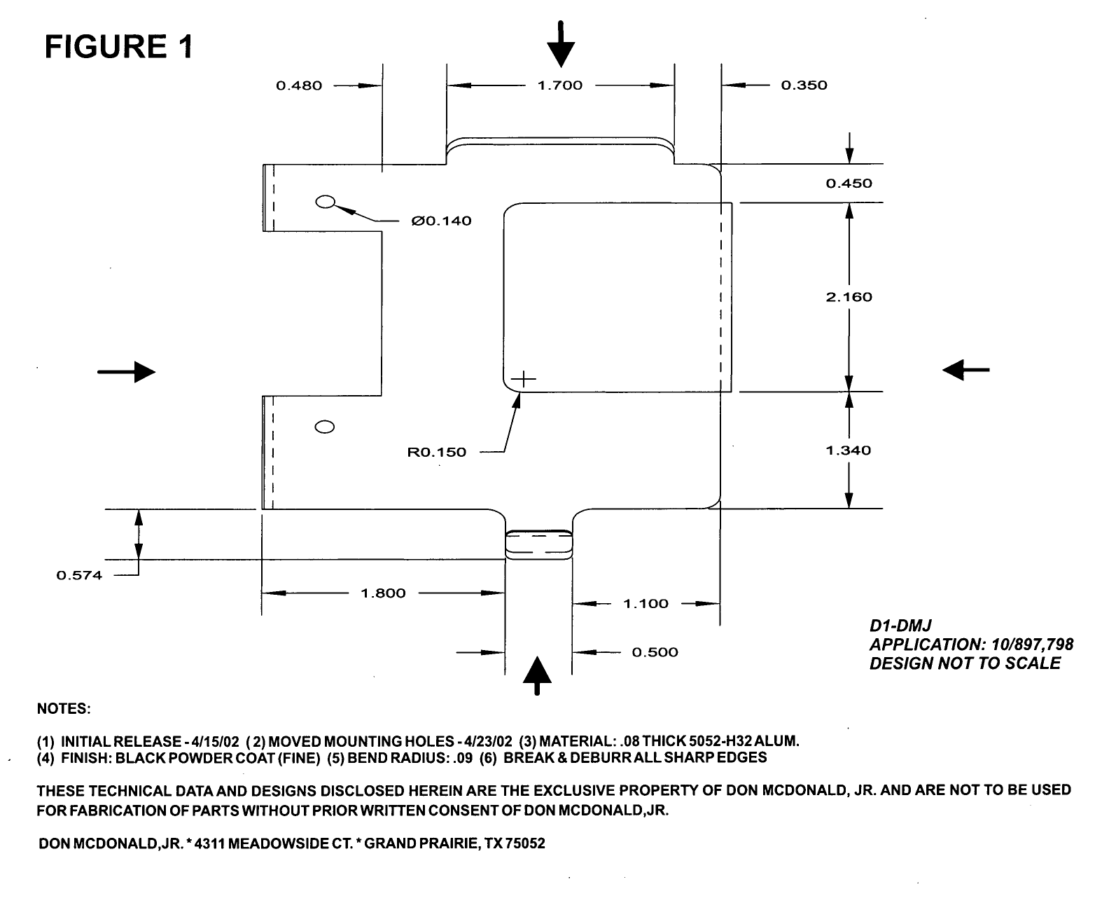

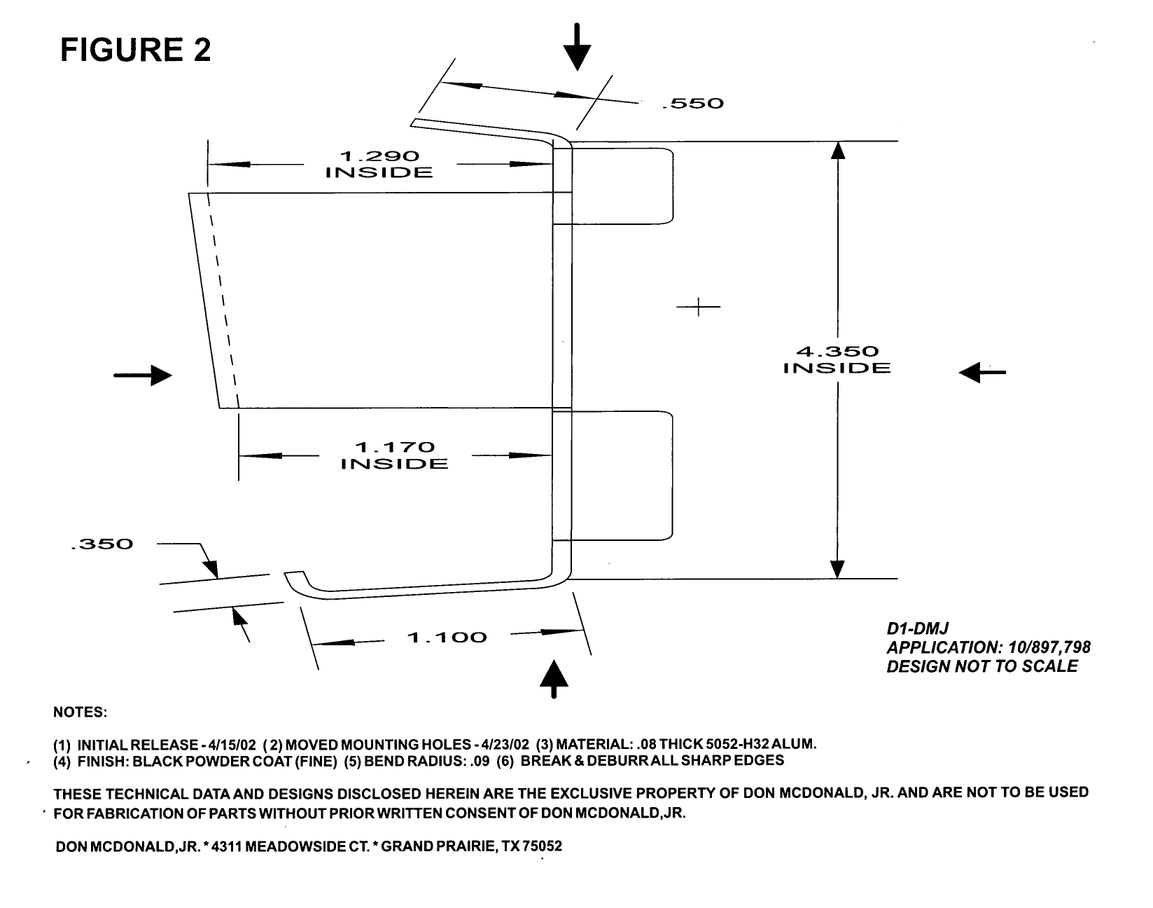

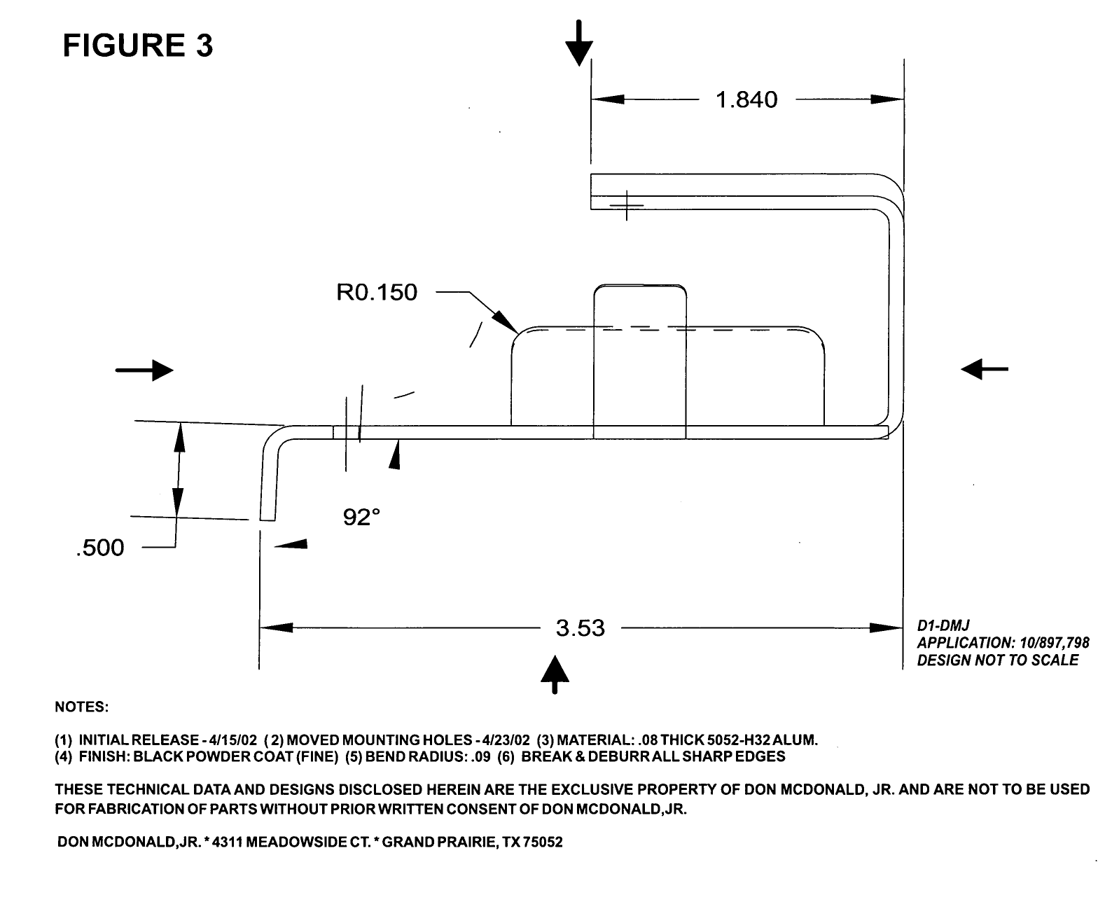

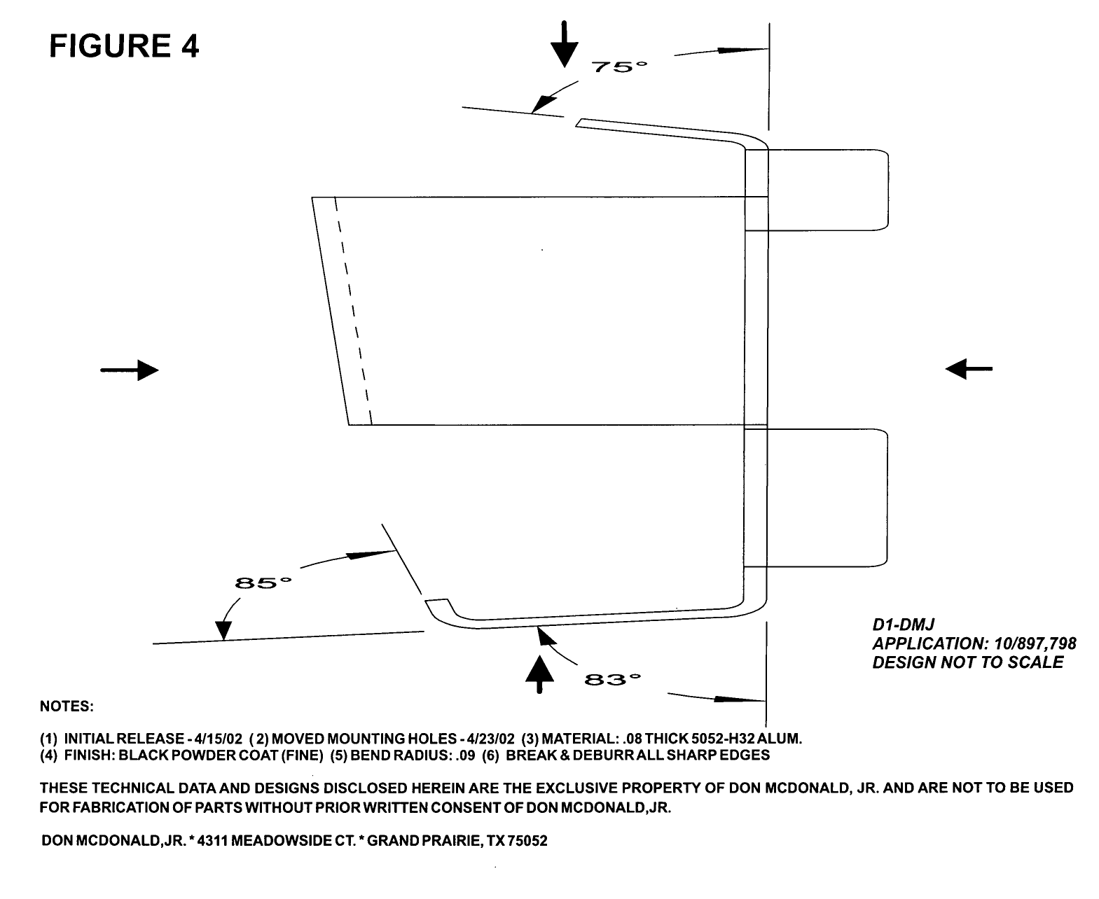

Specifically, the D1-DMJ bracket is intended to protect the unauthorized removal of the Plantronics® SQD headset base.

The SQD is inserted into the D1-DMJ bracket then installed on a call center telephone, i.e. an Aspect Communications® Teleset. The D1-DMJ requires an allen wrench to deinstall it from the telephone. The original color of the prototype bracket is black. It can however be customized to meet the color and logo specifications of the customer.

1. What I claim as my invention is the D1-DMJ bracket. The D1-DMJ bracket is intended to protect the unauthorized removal of a headset base from a call center telephone. The original color of the prototype bracket is black. It can however be customized to meet the color and logo specifications of the customer.
